(19) United States
(12) Patent Application Publication
(10) Pub. No.: US 2018/0239866 A1
(43) Pub. Date: Aug. 23, 2018

(54) PREDICTION OF GENETIC TRAIT EXPRESSION USING DATA ANALYTICS

(71) Applicant: International Business Machines Corporation, Armonk, NY (US)

(72) Inventors: SRINATH DESHAKULKARNI, BANGALORE (IN); DEEPAK GUPTA, INDIRAPURAM (IN); POOJA MALIK, NEW DELHI (IN); VIKRAM YADAV, FARRUKHABAD (IN)

(21) Appl. No.: 15/437,588

(22) Filed: Feb. 21, 2017

(51) Int. Cl. G06F 19/24; G06F 19/22; G06N 5/04; G06N 7/00

(52) U.S. Cl. CPC G06F 19/24; G06N 7/005; G06N 5/047; G06F 19/22

(57) ABSTRACT

A computer generates a matrix using genetic code. The computer generates a result-set using the matrix and neighborhood clustering. The computer determines a match between a portion of the result-set and a known genetic pattern. The computer responds to identification of a match between a portion of the result-set and a known genetic pattern by determining a probability that the combination of the first source of genetic code and the second source of genetic code will result in expression of a trait associated with the known genetic pattern. The computer responds to the probability at least meeting a threshold, by generating a message that indicates at least a portion of the genetic code of the progeny and the probability that the combination of the genetic code has the probability to result in expression of the trait associated with the known genetic pattern.

### BACKGROUND OF THE INVENTION

The present invention relates generally to the field of genetics, and more particularly to prediction of genetic trait expression.

Genetic variation is one of the driving forces of species evolution. However, that same variation also increases the challenge of predicting traits that will be expressed in progeny. Within a multicellular organism, there is typically variation in gene expression. Such variation is necessary for the formation of various tissues and organs of more complex organisms. With many species, two unique organisms contribute genetic code to their progeny. The specific genetic code that will be contributed by a given genetic source is varies from one progeny to the next. As such, there are many possible variations in the genetic code of progeny and the resulting trait expression in said progeny.

### SUMMARY

Embodiments of the present invention provide a method, system, and program product to predict genetic expression. One or more processors generate a matrix using a first source of genetic code and a second source of genetic code. The one or more processors generate a result-set using the matrix and neighborhood clustering. The one or more processors determine a match between a portion of the result-set and a known genetic pattern. The one or more processors respond to an identification of a match between a portion of the result-set and a known genetic pattern by determining a probability that the combination of the first source of genetic code and the second source of genetic code will result in expression of a trait associated with the known genetic pattern. The one or more processors respond to the probability at least meeting a first threshold by generating a message that indicates (i) at least a portion of predicted genetic code of the progeny and (ii) the probability that the combination of the first source of genetic code and the second source of genetic code has the probability to result in expression of the trait associated with the known genetic pattern.

### BRIEF DESCRIPTION OF THE SEVERAL VIEWS OF THE DRAWINGS

FIG. 1 is a functional block diagram illustrating a gene analysis environment, in accordance with an exemplary embodiment of the present invention.

FIG. 2 illustrates operational processes of genetic code analysis program, executing on a computing device within the environment of FIG. 1, in accordance with an exemplary embodiment of the present invention.

FIG. 3 depicts a block diagram of components of the computing device executing the genetic code analysis program, in accordance with an exemplary embodiment of the present invention.

### DETAILED DESCRIPTION

Detailed embodiments of the present invention are disclosed herein with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

While solutions to predict genetic expression, i.e., expression of a given trait, are known, they are typically reliant of the existence of actual genetic material, which is typically donated by the organism being assessed.

Embodiments of the present invention recognize that analysis of the genetic code of a potential genetic source can be leveraged to predict the probability of trait expression in a progeny of that genetic source. Embodiments of the present invention provide an analysis of the genetic code from genetic sources to identify and predict possible trait expression in progeny of those genetic sources. Some embodiments provide an analysis that utilizes two or more genetic sources to predict trait expression in progeny that could result from combinations of genetic code from those two or more genetic sources. Embodiments of the present invention provide a predicted transcription of genetic code in progeny based on theoretical genetic code contributed by the ancestor of that progeny. Embodiments of the present invention provide an analysis of predicted RNA production after the transcription of DNA. Embodiments of the present invention provide and leverage an analysis of genetic code that utilizes storing of a genetic sequence in the form of a matrix to predict gene expression.

Some embodiments of the present invention provide storage of the genetic sequence of two genetic sources in the form of 2-dimensional matrix. For example, in one scenario and embodiment, a first genetic sequence is placed on the X-axis of the matrix and a second genetic sequence is placed on the Y-axis of the matrix to create matrix of m*n. Now, from any point, the matrix is traversable as a combination of 4*1 in all eight dimension since, in this lattice, eight dimension will be visible from the unit point. The embodiment then creates a result-set is created based on the genetic code patterns by using k-Neighborhood clustering algorithms. For example, in a 4*1 matrix: neighboring clusters in the matrix are horizontally, vertically and diagonally located from a value in the matrix. Note that in some embodiments and scenarios, the value of “k” is not set for the k-Neighborhood clustering algorithms. Instead, the value of “k” is determined based, at least in part, on the size of the sample space. The embodiment forms one or more K shell multi-cell clusters from which a database query determines a desired pattern of genetic code. An intermediate result is the genetic sequence of the progeny and identification of the faulty patterns within that progeny, i.e. a known genetic sequence for a trait. As used herein, a final result is a modified genetic sequence of the progeny with a desired set of traits.

Some embodiments of the present invention provide identification of possible trait expression by matching the genetic sequence with existing genetic patterns, which are already stored for reference.

Some embodiments of the present invention use a database scan algorithm to identify the position of a first genetic trait pattern. After identifying the pattern, the genetic code is modified using a dummy pattern. After checking for possible genetic expression, one embodiment reiterates this process until the all known, or probable, genetic expression patterns are identified and modified using addition of or replacement with one or more dummy patterns. Embodiments of the present invention recognize that, in some scenarios, the addition of a dummy pattern can result in the formation of a genetic pattern that corresponds to another known genetic expression pattern. As such, the new genetic sequence, which includes one or more portions that have been replaced with dummy patterns, is analyzed using a similar process to identify one or more specific genetic patterns and to verify the complete removal of the genetic pattern that was modified using the dummy pattern.

Some embodiments of the present invention provide analysis results of various genetic sources that are generated using array comparative genomic hybridization (array CGH), which has demonstrated value for analyzing DNA copy number variations. Array CGH (Comparative Genomic Hybridization) has the capacity to examine chromosomes at a much higher resolution than other cytogenetic techniques. Copy-number variation presents an opportunity in various areas of genetics. For example, some embodiments of the present invention appreciate the significance of normal copy-number variation involving large segments of DNA. Although array CGH has established the existence of copy number polymorphisms in the various genomes, the picture of this normal variation can be incomplete. In some cases, measurement noise inhibits detection of polymorphisms that involve genomic segments of many kilo-bases or larger. Further, in some scenarios, genome coverage is less comprehensive if a given group of potential genetic sources has not been adequately sampled.

A comprehensive understanding of these normal variations is of biological interest and is used for interpretation of array CGH data and its relation to phenotype. Furthermore, some embodiments of the present invention leverage understanding the copy number polymorphisms that are detectable by a particular array CGH technique such that normal variations are not falsely associated with trait expression, and, conversely, to determine if some so-called normal variation may underlie phenotypic characteristics such as expression of a particular genetic trait.

However, embodiments of the present invention recognize that prediction of trait expression, resulting from a combination of two different genetic sequences, is of further biological interest. However, because of the magnitude of the number of variations that exist in the genetic material and the existence of normal copy number abnormalities, sophisticated analysis tools may be required to interpret the results of any genetic evaluation. This complexity grows when two different genetic sequences are theoretically combined and the resulting genetic sequence and its trait expression are predicted. As such, embodiments of the present invention are clearly seen to surpass mere identification of a given trait and its expression using known testing techniques.

Embodiments of the present invention analyze multi-cellular automata with a K cluster neighborhood (i.e. nearest neighbor) algorithm and map reduce jobs mechanisms to predict trait expression.

The present invention will now be described in detail with reference to the Figures.

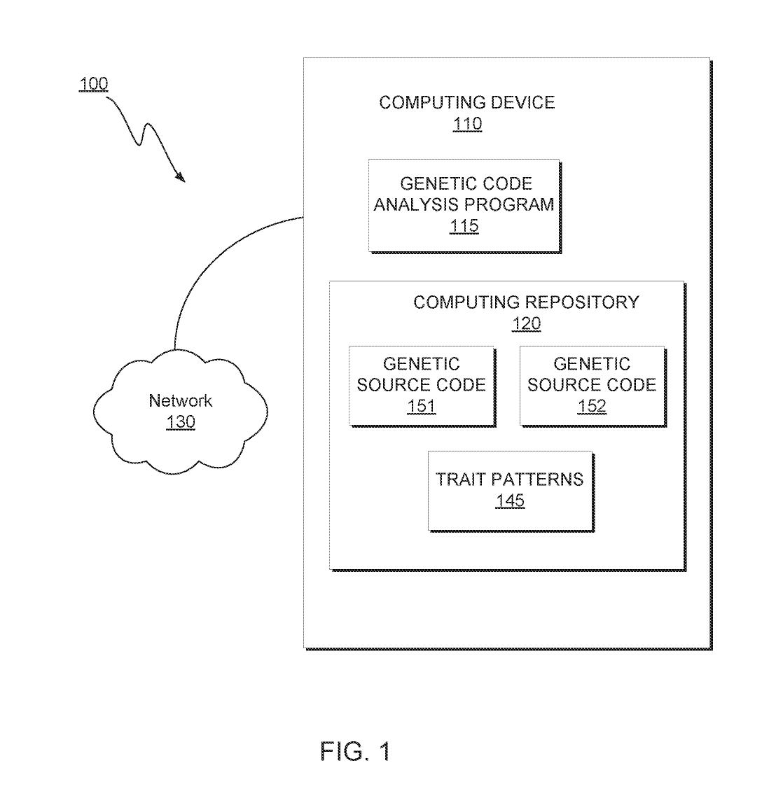

FIG. 1 is a functional block diagram illustrating gene analysis environment, generally designated 100, in accordance with one embodiment of the present invention. Gene analysis environment 100 includes computing device 110 and computing repository 120, connected over network 130. Computing device 110 includes genetic code analysis program 115. Computing repository 120 includes trait patterns 145, genetic source code 151 and genetic source code 152.

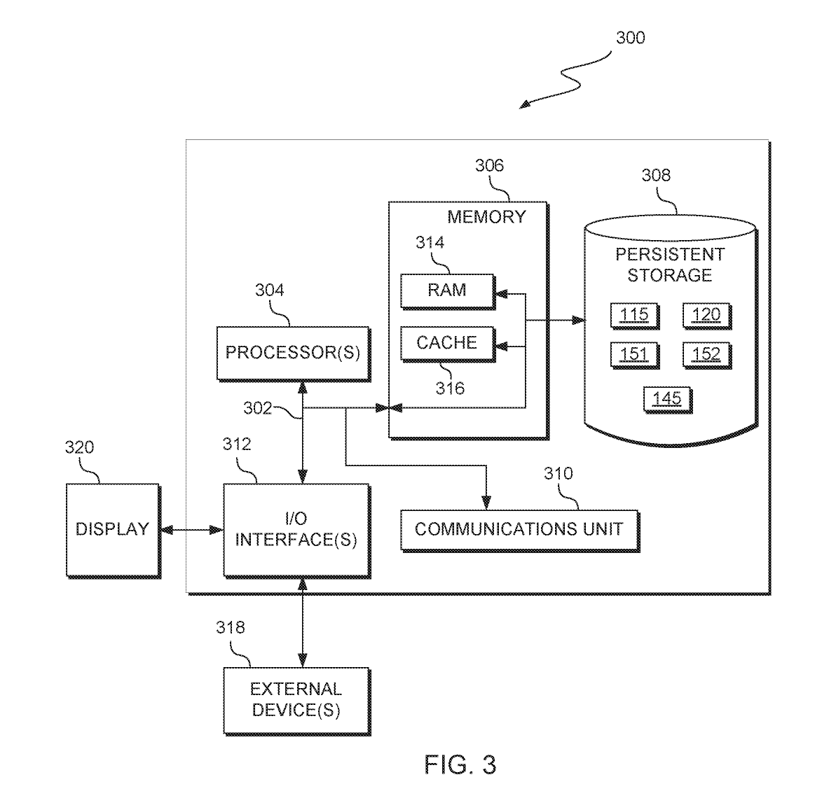

In various embodiments of the present invention, computing device 110 and computing repository 120 are, respectively, a computing device that can be a standalone device, a server, a laptop computer, a tablet computer, a netbook computer, a personal computer (PC), or a desktop computer. In another embodiment, one or both of computing device 110 and computing repository 120 represent a computing system utilizing clustered computers and components to act as a single pool of seamless resources. In general, computing device 110 and computing repository 120 can be any computing device or a combination of devices with access to genetic code analysis program 115, trait patterns 145, genetic source code 151, and genetic source code 152, and is capable of executing genetic code analysis program 115. One or both of computing device 110 and computing repository 120 may include internal and external hardware components, as depicted and described in further detail with respect to FIG. 3.

In this embodiment, computing repository 120 includes analysis results of various genetic sources. In one embodiment, the analysis results of various genetic sources included in computing repository 120 are generated using array comparative genomic hybridization (array CGH). In general, computing repository 120 includes the determined genetic patterns of various genetic sources (for example, genetic source code 151 and genetic source code 152) that are used by genetic code analysis program 115 to predict the genetic code of possible progeny. Further, computing repository 120 includes a repository of known genetic traits, herein denoted trait patterns 145, which are genetic sequences/patterns that are known to result in the expression of various traits when present and active in a given progeny.

In this exemplary embodiment, genetic code analysis program 115, genetic source code 151, and genetic source code 152 are respectively stored on computing device 110 and computing repository 120. However, in other embodiments, genetic code analysis program 115, genetic source code 151, and genetic source code 152 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between computing device 110, computing repository 120, genetic code analysis program 115, genetic source code 151, and genetic source code 152, in accordance with a desired embodiment of the present invention.

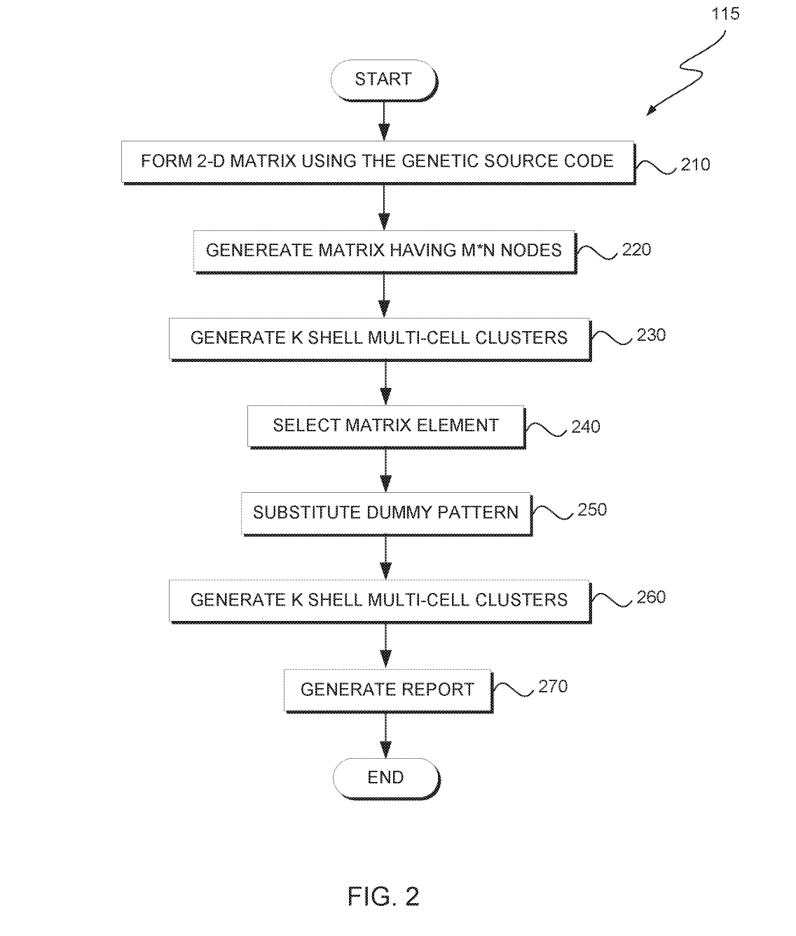

FIG. 2 illustrates operational processes of genetic code analysis program 115, executing on a computing device within the environment of FIG. 1, in accordance with an exemplary embodiment of the present invention.

In process 210, genetic code analysis program 115 retrieves genetic source code 151 and genetic source code 152 from computing repository 120. Genetic source code 151 and genetic source code 152 are then respectively stored in the form of a 2-dimensional matrix. In one example, genetic source code 151 and genetic source code 152 are placed on a result space, e.g., the x-axis and y-axis of a Cartesian plane, or binary vectors in a data space representing the spatial nature of cluster analysis. In various embodiments, there is a dimensionality reduction of K dimensions to two dimensions. As such, in some embodiments, a data dictionary is generated for genetic source code 151 and genetic source code 152 such that each has a 4*1 matrix entered as one variable and the resultant of the first and second genetic sequences is placed on one axis.

In process 220, genetic code analysis program 115 generates a matrix having m*n nodes. For example, a result-set is formed based on a genetic code pattern like 4*1 matrix: horizontally, vertically and diagonally by using k-Neighborhood clustering algorithms. In one embodiment, “m” is the number of bases, which is a constant, such as four, while “n” is the number of genes to be compared. In some embodiments and scenarios, the “space” of certain initial genes is filled with dummy genes, post filtering, to achieve certain trait expressions in progeny. For example, in one embodiment and scenario, it is assumed that each gene is consisted of four nucleotides. Further, that gene has a corresponding dummy pattern that enables the expression of a certain trait. The substitution of that dummy pattern in the “space” of certain initial genes results in the expression of the dummy pattern in place of those initial genes.

In process 230, genetic code analysis program 115 generates K shell multi-cell clusters. In general, the size of K depends on the sample size. Further, as the size of K increases, the more reliable and accurate the predicted trait expression becomes.

In process 240, genetic code analysis program 115 selects a given matrix element, for example A{0,0}, and matches that element of the K shell multi-cell clusters against various genetic patterns included in trait patterns 145. In some embodiments and scenarios, there are multiple clusters are analyzed. For example, if K=3, then three neighboring elements (e.g., the three closest elements) are analyzed for member selection of the given matrix element. In one such scenario, an average/frequent pair is selected. For example, in one such embodiment and scenario, the clusters are selected based on mean distance between the intramolecular distances.

In process 250, genetic code analysis program 115 substitutes a “dummy” pattern for a given genetic pattern included in the K shell multi-cell clusters that matched with a given genetic patterns included in trait patterns 145. In other words, a portion of the genetic code included in the K shell multi-cell clusters is replaced with the “dummy” pattern. In some scenarios, this replacement impacts clustering. For example, the greater the data dispersion, the greater the number of clusters that need to be traversed. In some embodiments, certain genetic traits/code patterns are known to be present in certain regions. As such, genetic code analysis program 115 compares those regions included in the K shell multi-cell clusters to various genetic patterns that are common to those regions. Note that in some embodiments and scenarios filtering is performed earlier. However, removal or movement of points in the data space can result in changes to the clustering. In some embodiments, it is determined whether to perform filtering sooner or later in the process, i.e., at what point in the process the filtering is to be performed, based on (i) a predicted reduction in computation cost resulting from earlier filtering and (ii) a predicted decrease in the predictability of trait expression.

In process 260, genetic code analysis program 115 continues to analyze the, now modified, K shell multi-cell clusters. As such, genetic code analysis program 115 determines whether the removal of that particular genetic sequence from the K shell multi-cell clusters results in the formation of another genetic pattern included in trait patterns 145. For example, a genetic sequence includes sequence portions A, B, and C (i.e. A-B-C is the entire genetic sequence). Sequence portion B is matched to a genetic pattern included in trait patterns 145 and removed using a “dummy” pattern. As such, the modified code now reads A-C. However, A-C itself matches a genetic pattern included in trait patterns 145. As such, genetic code analysis program 115 determines that removal of sequence portion B results in the formation of a genetic trait corresponding to A-C. Note that in this example, removal and replacement of sequence portions affects the level of clustering. Further, it also affects the computation cost and inversely affects the predictability of trait expression.

In process 270, code analysis program 115 generates a report detailing the traits identified in genetic source code 151 and genetic source code 152 and the likely trait expression that would result from the combination of genetic source code 151 and genetic source code 152, i.e. the likely traits of the progeny resulting from the combination of genetic source code 151 and genetic source code 152. In this embodiment, the combination of genetic source code 151 and genetic source code 152 are compared to trait patterns 145 and the result of this comparison is included as part of the report.

In some embodiments, code analysis program 115 is configured to select various genetic sources for production of progeny through more than one generation. For example, code analysis program 115 selects twenty genetic sources to start, with each of those sources having a probability of expressing a trait that is desired. Code analysis program 115 then determines which combinations of those genetic sources, and the combinations of the resulting progeny, are statistically likely, i.e., above a threshold, to result in production of an organism with certain traits being expressed or repressed. As such, code analysis program 115 is configured to automatically select various genetic sources, including progeny thereof, for future combinations to yield the desired trait expression.

In one embodiment and example, computing repository 120 includes numerous genetic codes for flowers of a range of sizes and colors. As such, there are two sets of genetic source code 151 and two sets of genetic source code 152 that respectively represent four such flowers, designated A1, A2, B1 and B2. Note that there are genetic differences between all of A1, A2, B1 and B2. However, A1 and A2 each have certain common traits that are not found in either B1 or B2. Likewise, B1 and B2 have certain common traits that are not found in either A1 or A2. When genetic code analysis program 115 analyses genetic source code 151 and genetic source code 152 the result of the analysis indicates various traits combinations that are likely going to be expressed in the progeny that results from the combinations of flowers A1, A2, B1 and B2. For example, combinations of A1 and either A2 or B1 result in a high probability that trait Z1 will be expressed. Further, the combination of B2 with either A2 or B1 result in a high probability that trait Z2 will be expressed. However, trait Z1 results in a purple flower and a plant producer has an order for blue flowers, which is only expressed by trait Z2. As such, the plant producer knows that the progeny of B2 with either A2 or B1 will most likely result in blue flowers, thereby allowing them to meet the order specifications.

In another example, the trait Z3 is only likely to be expressed after two generations of progeny have been produced. In continuation of the above example, no first generation combination of flowers A1, A2, B1 and B2 result in a high probability of trait Z3 being strongly expressed. However, in some embodiments and scenarios, code analysis program 115 predicts that the progeny of A1 and A2 results in progeny C1 that has the genetic code for trait Z3 but it is not likely to be expressed. Further, code analysis program 115 predicts that the progeny of B1 and B2 results in progeny C2 that has a strong expression of the genetic code for trait Z4, which utilizes the same expression controlling sequence as Z3, but C2 itself does not have trait Z3. Both C1 and C2 represent a first generation of progeny. Code analysis program 115 analyses the probable traits of progeny resulting from C1 and C2 and determines that there is a fifty percent chance that a given progeny of C1 and C2 will have trait Z3 strongly expressed, i.e. the second generation, the progeny of C1 and C2, will have trait Z3 strongly expressed. Note that there is no apparent quality, discernable via examination by the plant producer, that the production of C1 and C2 will result in a flower that has trait Z3 being strongly expressed, i.e. the progeny C1 and C2. As such, the plant producer is able to provide plants with trait Z3 strongly expressed in two generations, which is, as one skilled in the art recognizes, significantly fewer generations than would have been possible (within reason) using trial and error or an educated guess. In one embodiment, the process finishes once all the non-terminal strings are replaced with terminal strings, which is dictated by Autometa theory.

One of ordinary skill in the art recognizes that the types of genetic code included in computing repository 120 that are analyzed by code analysis program 115 can vary from one embodiment to another.

In one embodiment, one or more traits are identified by code analysis program 115. For example, a user selects a number of traits they want to have present in an organism. Code analysis program 115 accesses computing repository 120 and determines a combination of genetic sources and their resulting progeny that are likely to yield a final progeny with the desired traits.

In general, such an analysis includes a prediction that the combinations of genetic sources that will yield the desired traits, which is above a threshold. In some embodiments and scenarios, code analysis program 115 searches other databases and identifies alternative genetic sources that include traits that may increase the probability that the combinations will yield the desired traits. In some such embodiments, the report can indicate an alternative combination of genetic source material that includes those sources, if those sources are available. In some such scenarios, metadata associated with those alternative genetic sources are provided in the report. For example, location information and/or instructions indicating how that alternative genetic source material may be obtained.

In some embodiments and scenarios, the analysis indicates what the probability is based on the “best fit” of genetic sources that are available, i.e., represented in computing repository 120. In general, a “best fit” is a combination of genetic sources that yield a progeny with at least some of the desired traits. In some embodiments, the best fit is identified as the progeny itself that has at least some of the desired traits and meets at least criteria regarding the creation of that progeny or a trait expressed by that progeny. Such a “best fit” may also take into account various constraints. For example, in some such scenarios and embodiments, a number of generations, i.e., a number of combinations of genetic material to yield that progeny are criteria. In one such scenario, a progeny with certain traits is to be produced utilizing ten or fewer generations, i.e. combinations of genetic sources that yield a progeny. As such, code analysis program 115 attempts to find “best fit” based on the combinations of genetic material that yield the highest number of those selected traits within a maximum of ten generations.

In some scenarios and embodiments, the report indicates one or more progeny with a number of the traits, which may be above a threshold. For example, six traits are desired to be present in a progeny that results from five or fewer generations and each acceptable progeny must have a minimum of four of those traits. The results indicate that there are three possible progeny that are statistically likely to be produced within five or fewer generations, based on the available genetic sources. Each of these produced progeny has a different combination of five to six of the six indicated traits. In this example, a first and second of the three possible progeny have a different combination of five of the six traits respectively, and both of those progeny each have a ninety percent chance of being produced. However, the third possible progeny has all six traits but only has a fifty percent chance of being produced.

As such, the report reflects (i) the three possible progeny, (ii) the selected traits they each are likely to express, (iii) the likelihood of producing a given progeny, and (iv) the combinations of genetic source material that are predicted to result in production of that given progeny. In some embodiments and scenarios, regardless of some of the constraints, the number of generations that are predicted, i.e., statistically likely above a threshold, to yield a progeny with all of the traits is also included in the report. For example, the report also indicates that the second of the three possible progeny has a ninety-five percent change to yield all six of the traits in a progeny if the utilized as a genetic source for a sixth generation. As such, while the second progeny does not meet all of the constraints, all six traits in five or fewer generations, it is the best fit since a single following generation, is likely to have all six traits. Therefore, the report can reflect, for each given progeny, a weighted value that reflects a weight for one or more of (i) a number possible progeny, (ii) one or more traits the progeny is predicted to express, (iii) an overall probability of producing the progeny, (iv) a number of combinations of genetic source material that are predicted to result in production of the progeny, and (v) the number of generations needed to produce that progeny. It is noted that two equivalent “best fits” for the same set of traits may result from various combinations of source material as a result of a set of rules being applied to determine a “best fit”. For example, two different progeny each express that same five traits. Further, the expression of those traits is predicted to be achieved using different sources of genetic material. For the first progeny, the combination of traits was reached using two generations and four sources of genetic material (A1, A2, A3, and A4). In contrast, three generations were required to have that same combination of traits in the second progeny using six sources of genetic material (B1, B2, B3, B4, B5, and B6). In this example, the sources of genetic material used for the second progeny are weighted more highly than those of the first progeny. However, the number of generations required is also a weighted value that is used to determine the “best fit”. As such, both progeny have equivalent “best fit” values. In such scenarios, additional rules may be employed to break the tie. Alternatively, both possibilities are presented in the report as viable alternatives to each other. In general, combinations of genetic sources are selected to produce a progeny with a best fit to achieve the desired trait expression.

In some embodiments, a “best fit” is identified using one or more criteria and attributes that are weighted according to rules. For example, various weights are associated with number of generations, number of traits, specific traits, etc. As such, a progeny with the best fit has the greatest total weight of all such criteria.

FIG. 3 depicts a block diagram of components of the computing device executing genetic code analysis program 115, in accordance with an exemplary embodiment of the present invention.

FIG. 3 depicts a block diagram, 300, of components of computing device 110 and computing repository 120 respectively, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Genetic code analysis program 115, trait patterns 145, genetic source code 151, and genetic source code 152 are stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of network 130. In these examples, communications unit 310 includes one or more network interface cards. Communications unit 310 may provide communications through the use of either or both physical and wireless communications links. Genetic code analysis program 115, trait patterns 145, genetic source code 151, and genetic source code 152 may be downloaded to persistent storage 308 through communications unit 310.

I/O interface(s) 312 allows for input and output of data with other devices that may be respectively connected to computing device 110 and computing repository 120. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., genetic code analysis program 115, trait patterns 145, genetic source code 151, and genetic source code 152, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as, for example, “Smalltalk” and the like may be subject to trademark rights in various jurisdictions throughout the world and are used here only in reference to the products or services properly denominated by the marks to the extent that such trademark rights may exist.

What is claimed is:

1. A method of predicting genetic pattern expression, the method comprising:
generating, by one or more processors, a matrix using a first source of genetic code and a second source of genetic code;
generating, by the one or more processors, a result-set using the matrix and neighborhood clustering;
determining, by the one or more processors, a match between a portion of the result-set and a known genetic pattern;
responsive to an identification of a match between a portion of the result-set and a known genetic pattern, determining, by the one or more processors, a probability that the combination of the first source of genetic code and the second source of genetic code will result in expression of a trait associated with the known genetic pattern; and
responsive to the probability at least meeting a first threshold for expression of the trait, generating, by the one or more processors, a message that indicates (i) at least a portion of predicted genetic code of the progeny and (ii) the probability that the combination of the first source of genetic code and the second source of genetic code has the probability to result in expression of the trait associated with the known genetic pattern.

2. The method of claim 1, wherein the trait is predicted to be expressed in a progeny that includes a combination of at least a portion of genetic code from the first source of genetic code and the second source of genetic code.

3. The method of claim 1, the method comprising:
generating, by the one or more processors, one or more shell multi-cell clusters based, at least in part, on the matrix.

4. The method of claim 1, the method comprising:
substituting, by the one or more processors, a virtual non-coding sequence of genetic code for the portion of the result-set; and
determining, by the one or more processors, whether substitution of the virtual non-coding sequence of genetic code for the portion of the result-set results in a reduction in probable expression of the trait.

5. The method of claim 1, the method comprising:
generating, by the one or more processors, a plurality of combinations of sources of genetic code that are predicted to yield a progeny that has the probability to result in expression of the trait associated with the known genetic pattern.

6. The method of claim 5, the method comprising:
generating, by the one or more processors, a weighted value for the progeny, wherein the weighted value reflects a weight for an attribute that is based, at least in part, on at least one of: (i) a number possible progeny that at least meet a second threshold for expression of the trait, (ii) one or more traits the progeny is predicted to express, (iii) an overall probability of producing the progeny, (iv) a number of combinations of genetic source material that are predicted to result in production of the progeny, and (v) the number of combinations of genetic code that are needed to produce that progeny.

7. The method of claim 5, the method comprising:
generating, by the one or more processors, a sequence of combinations of genetic code, from a plurality of sources of genetic code, that have at least a third threshold amount of prediction to result in the production of at least one progeny with expression of the trait associated with the known genetic pattern.

8. The method of claim 5, the method comprising:
responsive to a predicted generation of a given progeny with a predicted expression of the trait that is below the first threshold, determining at least one of (i) a third source of genetic code and (ii) a required number of combinations of genetic code that result in a probability that a subsequent progeny, which incorporates at least a portion of genetic code of the given progeny, will have an increased predicted expression of the trait.

9. A computer program product for predicting genetic pattern expression, the computer program product comprising:
one or more computer-readable storage media and program instructions stored on the one or more computer-readable storage media, the program instructions comprising:
program instructions to generate a matrix using a first source of genetic code and a second source of genetic code;
program instructions to generate a result-set using the matrix and neighborhood clustering;
program instructions to determine a match between a portion of the result-set and a known genetic pattern;
program instructions to respond to an identification of a match between a portion of the result-set and a known genetic pattern by determining a probability that the combination of the first source of genetic code and the second source of genetic code will result in expression of a trait associated with the known genetic pattern; and
program instructions to respond to the probability at least meeting a first threshold by generating a message that indicates (i) at least a portion of predicted genetic code of the progeny and (ii) the probability that the combination of the first source of genetic code and the second source of genetic code has the probability to result in expression of the trait associated with the known genetic pattern.

10. The computer program product of claim 9, wherein the trait is predicted to be expressed in a progeny that includes a combination of at least a portion of genetic code from the first source of genetic code and the second source of genetic code.

11. The computer program product of claim 9, the program instructions further comprising:
program instructions to generate one or more shell multi-cell clusters based, at least in part, on the matrix.

12. The computer program product of claim 9, the program instructions further comprising:
program instructions to substitute a virtual non-coding sequence of genetic code for the portion of the result-set; and
program instructions to determine whether substitution of the virtual non-coding sequence of genetic code for the portion of the result-set results in a reduction in probable expression of the trait.

13. The computer program product of claim 9, the program instructions further comprising:
program instructions to generate a plurality of combinations of sources of genetic code that are predicted to yield a progeny that has the probability to result in expression of the trait associated with the known genetic pattern.

14. The computer program product of claim 13, the program instructions further comprising:
program instructions to generate a weighted value for the progeny, wherein the weighted value reflects a weight for an attribute that is based, at least in part, on at least one of: (i) a number possible progeny that at least meet a second threshold for expression of the trait, (ii) one or more traits the progeny is predicted to express, (iii) an overall probability of producing the progeny, (iv) a number of combinations of genetic source material that are predicted to result in production of the progeny, and (v) the number of combinations of genetic code that are needed to produce that progeny.

15. The computer program product of claim 13, the program instructions further comprising:
program instructions to generate a sequence of combinations of genetic code, from a plurality of sources of genetic code, that have at least a third threshold amount of prediction to result in the production of at least one progeny with expression of the trait associated with the known genetic pattern.

16. The computer program product of claim 13, the program instructions further comprising:
program instructions to respond to a predicted generation of a given progeny with a predicted expression of the trait that is below the first threshold by determining at least one of (i) a third source of genetic code and (ii) a required number of combinations of genetic code that result in a probability that a subsequent progeny, which incorporates at least a portion of genetic code of the given progeny, will have an increased predicted expression of the trait.

17. A computer system for predicting genetic pattern expression, the computer system comprising:
one or more computer processors;
one or more computer readable storage medium;
program instructions stored on the computer readable storage medium for execution by at least one of the one or more processors, the program instructions comprising:
program instructions to generate a matrix using a first source of genetic code and a second source of genetic code;
program instructions to generate a result-set using the matrix and neighborhood clustering;
program instructions to determine a match between a portion of the result-set and a known genetic pattern;
program instructions to respond to an identification of a match between a portion of the result-set and a known genetic pattern by determining a probability that the combination of the first source of genetic code and the second source of genetic code will result in expression of a trait associated with the known genetic pattern; and
program instructions to respond to the probability at least meeting a first threshold by generating a message that indicates (i) at least a portion of predicted genetic code of the progeny and (ii) the probability that the combination of the first source of genetic code and the second source of genetic code has the probability to result in expression of the trait associated with the known genetic pattern.

18. The computer system of claim 17, the program instructions further comprising:
program instructions to generate one or more shell multi-cell clusters based, at least in part, on the matrix.

19. The computer system of claim 17, the program instructions further comprising:
program instructions to substitute a virtual non-coding sequence of genetic code for the portion of the result-set; and
program instructions to determine whether substitution of the virtual non-coding sequence of genetic code for the portion of the result-set results in a reduction in probable expression of the trait.

20. The computer system of claim 17, the program instructions further comprising:
program instructions to generate a plurality of combinations of sources of genetic code that are predicted to yield a progeny that has the probability to result in expression of the trait associated with the known genetic pattern.
